(19) United States
(12) Patent Application Publication
(10) Pub. No.: US 2025/0270087 A1
(43) Pub. Date: Aug. 28, 2025

(54) Generating Hydrogen Via Methane Pyrolysis To Power Oilfield Equipment

(71) Applicant: Halliburton Energy Services, Inc., Houston, TX (US)

(72) Inventors: Philip D. Nguyen, Houston, TX (US); Ronald Glen Dusterhoft, Houston, TX (US); Stanley Vernon Stephenson, Duncan, OK (US)

(73) Assignee: Halliburton Energy Services, Inc., Houston, TX (US)

(21) Appl. No.: 18/590,734

(22) Filed: Feb. 28, 2024

(51) Int. Cl. C01B 3/24; H01M 8/0612

(52) U.S. Cl. CPC C01B 3/24; H01M 8/0612; C01B 2203/0266; C01B 2203/066; C01B 2203/0838; C01B 2203/1241; C01B 2203/84

(57) ABSTRACT

Provided are methods and systems to convert a one-carbon-containing molecule through pyrolysis reactions into solid carbon and molecular hydrogen gas without emission of carbon dioxide. The methods may include converting the one-carbon-containing molecule into electricity with a co-production of carbon dioxide, pyrolyzing at least methane to produce at least carbon and hydrogen, and reacting at least a portion of the carbon dioxide and at least a portion of the hydrogen to produce at least additional one-carbon-containing molecule. In other examples, the methods may include pyrolyzing methane to produce at least solid carbon and hydrogen, feeding at least a portion of the hydrogen to a fuel cell to produce electricity and heat, capturing at least a portion of the heat from the fuel cell, preheating the methane prior to the pyrolyzing with the captured heat from the fuel cell, and powering oilfield equipment with at least a portion of the electricity.

### BACKGROUND

During the drilling and completion of oil and gas wells, various wellbore treatments are performed on the wells for a number of purposes. For example, hydrocarbon-producing wells are often stimulated by hydraulic fracturing operations, wherein a servicing fluid such as a fracturing fluid may be introduced into a portion of a subterranean formation penetrated by a wellbore at a hydraulic pressure sufficient to create or enhance fractures therein. Such a fracturing treatment may increase hydrocarbon production from the well.

At a well stimulation site, there are typically several large pieces of fracturing (or other well stimulation) equipment on location that must be powered including, but not limited to, mixers, liquid handling equipment, sand handling equipment, downhole blenders, a plurality of high-pressure hydraulic pumping units, and a control center. The equipment on location is used to deliver large quantities of fluid/proppant mixtures to a wellhead at high-pressures to perform the desired operations. Often, the hydraulic pumping units and other machinery on location are powered by internal combustion engines such as diesel-cycle internal combustion engines. In general, these diesel engines operate at relatively low efficiencies (e.g., approximately 32%). The stimulation site will often include several individual diesel-powered units (e.g., pumping units, blenders, etc.) that must be refueled multiple times a day throughout a multi-stage stimulation operation.

Hydrogen is seen as one of the most promising energy vectors to replace hydrocarbon-based fuel including diesel fuel. Hydrogen can be used to directly drive equipment, such as by combustion of the hydrogen, or may be used in a fuel cell to generate electricity which may then be used to power equipment. Many efforts are being made to produce hydrogen without any carbon dioxide (CO₂) emission via water electrolysis powered by renewable energy, for instance. Another method to produce hydrogen is conventional coal gasification and steam methane reforming processes; however, these techniques are undesirable due to carbon dioxide emissions. Thermal decomposition of methane produces hydrogen and solid carbon, and thus, the release of greenhouse gases is prevented.

### BRIEF DESCRIPTION OF THE DRAWINGS

These drawings illustrate certain aspects of some of the embodiments of the present disclosure and should not be used to limit or define the disclosure.

FIG. 1 is a schematic illustration of a system in accordance with some embodiments of the present disclosure.

FIG. 2 is a schematic illustration of a methane fuel cell in accordance with some embodiments of the present disclosure.

FIG. 3 is a schematic illustration of a generator in accordance with some embodiments of the present disclosure.

FIG. 4 is a schematic block diagram of a fracturing spread where fuel-cell powered fracturing equipment may be employed in accordance with some embodiments of the present disclosure.

### DETAILED DESCRIPTION

Disclosed herein are methods and systems to convert methane through pyrolysis reactions into solid carbon and molecular hydrogen gas without emission of carbon dioxide. In some embodiments, the hydrogen may be used to supply a hydrogen fuel cell to power oilfield equipment and/or recharge an energy storage for future electricity use. In some embodiments, the hydrogen may be used for reaction with carbon dioxide to reduce carbon dioxide emissions from a fuel cell (e.g., methane or methanol fuel cell).

Methane pyrolysis includes heating methane under conditions to thermally crack methane into molecular hydrogen gas and solid carbon where the overall reaction is shown by Reaction 1 below.

$${CH}_{4} ( g ) {\to }^{△} C ( s ) + 2 {H}_{2} ( g ) Δ H ° = 74.91 \frac{kJ}{mol} \qquad Reaction 1$$

Thermal cracking may occur at temperature around 1100° C. or more, or 1200° C. or more in a non-catalytic process as methane is a very stable molecule due to the strong C—H bonds and the symmetry of its molecular structure. However, the incorporation of a catalyst can significantly reduce the reaction temperature depending upon its nature. The catalyst includes any catalyst capable of lowering the activation energy of the reaction including metal and non-metal catalysts. Conventional metal catalysts include nickel, cobalt, and iron, for example. Iron catalyst can lower the reaction temperatures to 700° C. for a certain period of time, for instance. A metal promoter may be incorporated to extend the lifetime of metal catalysts. Metal promoters include palladium and copper, for example. Carbon catalyst is a good example of a non-metal catalyst due to their high catalytic activity and high stability. Molten metals (titanium, lead, or tin), molten metal alloys (nickel-bismuth, copper-bismuth), and molten salts (potassium bromide, sodium bromide, sodium chloride, sodium fluoride, manganese (II) chloride, potassium chloride) can be alternative catalyst. However, their thermal stability above 1000° C. can be a challenge. Methane pyrolysis is also affected by the reaction pressure, the reaction time, the reactor type, and the temperature ramping rate.

Methane pyrolysis occurs in the absence of oxygen where multiple endothermic reactions split C—H bonds to form carbon nanoparticles (C₍ₛ₎) and molecular hydrogen gas (H₂(g)). In embodiments, the methane pyrolysis is performed in a microwave pyrolysis reactor configured to perform microwave plasma pyrolysis and/or microwave-assisted pyrolysis, wherein the microwave plasma core temperature is higher than 1750° C. In embodiments, the microwave pyrolysis reactor comprises a plasma chamber, a microwave-feeding resonator with a microwave generator for forming the plasma and coupling points in the metal wall between the resonator and plasma chamber for coupling the microwave into the plasma chamber. In embodiments, an inlet stream containing methane is introduced into the plasma chamber and exposed to microwave plasma with a sufficient power density to cause at least a portion of the methane from the inlet stream to decompose to form molecular hydrogen gas and carbon nanoparticles. In further embodiments, the methane pyrolysis is performed in a plasma microwave pyrolysis reactor comprising a reaction chamber positioned within an opening of a waveguide and a microwave generator configured to generate microwaves and feed the microwaves into the waveguide. In embodiments, an inlet stream containing methane is introduced into the reaction chamber and microwave energy is propagated through the waveguide into the reaction tube at a sufficient power density to cause at least a portion of the methane from the inlet stream to decompose to form hydrogen and carbon nanoparticles.

An inlet stream to the microwave pyrolysis unit includes methane. The inlet stream may include pure methane or methane mixed with other hydrocarbons such as ethane, propane, butane, hexane, and heteroatom containing hydrocarbon species. For example, the inlet stream may include pipeline quality natural gas containing 92% by volume to 98% by volume methane with the balance being natural gas liquids and impurities. However, the inlet stream may only contain at least 70% by volume methane, 75% by volume, 80% by volume, 85% by volume, 90% by volume methane, or any range in between for the microwave pyrolysis reactor to function effectively. Methane gas (CH₄) can be released from wellheads as well as from various production equipment such as gas/liquid separators, oil/water separators, and other surface production equipment. Production storage tanks are used to hold produced liquids including crude oil, water, and gas condensate for periods before pipelining or other transportation of produced liquids. Crude oil and condensate may experience evaporation from temperature increases and pressure drops while in the storage tanks which cause gases dissolved in the liquid to flash out of the liquid phase to form a vapor phase which is rich in methane. The vapor phase may be captured and directed to microwave pyrolysis units described herein. Membrane separators, and/or metal organic frameworks, can be used to separate and purify methane from other gas components at the wellsite before capture. In some embodiments, the methane gas may include waste gas that is typically flared such as during the production and pipelining of hydrocarbons. In some embodiments, methane gas from a wellhead may be supplemented with additional methane fuel delivered to the location. Additional examples of suitable methane sources include captured methane from the wellhead, captured methane from landfills, captured methane from cattle and dairy farms, or captured methane from steam methane reforming. In further embodiments, the methane is included in a hydrocarbon mixture with other hydrocarbons, water, and/or sulfur containing compounds, for example. In embodiment, the feed to a decomposition reactor includes a Y-Grade hydrocarbon which may include hydrocarbons such as ethane, propane, butane, hexane. Y-grade is a natural gas liquid mixture that has been through field processing but has not been fractionated. Y-grade hydrocarbons are typically separated from natural gas before pipelining the natural gas product. In some examples, the inlet stream to the microwave pyrolysis unit includes produced methane, captured methane, or both.

Produced methane, such as from wellheads and gas/liquid separators may be distinguished from pipeline quality natural gas as the produced methane is present in a more dilute mixture with other hydrocarbons such as C₂-C₆ hydrocarbons as well as water, hydrogen sulfide, carbon dioxide, and nitrogen, for example. Specifications for pipeline quality natural gas can vary by pipeline carrier but typically includes specification for heating value and minimum content of methane of at least 70% by volume as well as a maximum total sulfur content (mercaptan and hydrogen sulfide) of 20 ppm per 100 standard cubic feet. In embodiments, the inlet stream to the microwave pyrolysis reactor includes produced methane wherein the inlet stream comprises methane in an amount of about 10% by volume to about 75% by volume with the balance being at least one of C₂-C₆ hydrocarbons as well as water, mercaptan, hydrogen sulfide, carbon dioxide, and nitrogen.

A product stream from the microwave pyrolysis unit includes molecular hydrogen gas and carbon nanoparticles. The product stream may further include pyrolysis products from the pyrolysis of other components in the inlet stream such as C₂-C₆ hydrocarbons as well as unreacted hydrocarbons and/or hydrogen sulfide, nitrogen, carbon dioxide, and water.

Generally, the term “nanoparticle” may be defined as a particle having a Dv50 particle size of less than 1 micron, for example; about 1 nanometer (“nm”) to about 950 nm, such as about 5 nm, about 10 nm, about 20 nm, about 30 nm, about 40 nm, about 50 nm, about 60 nm, about 70 nm, about 80 nm, or about 90 nm, about 100 nm, about 500 nm, about 750 nm, about 950 nm, or any ranges therebetween. The Dv50 particle size may also be referred to as the median particle size by volume of a particulate material. The Dv50 particle size is defined as the maximum particle diameter below which 50% of the material volume exists. The Dv50 particle size values for a particular sample may be measured by commercially available particle size analyzers such as those manufactured by Malvern Instruments, Worcestershire, United Kingdom. The carbon nanoparticles can include single wall carbon nanotubes, multi wall carbon nanotubes, fullerenes, graphene, and combinations thereof. Particulate, particle, and derivatives thereof as used in this disclosure, include, all known shapes of materials, including substantially spherical materials, low to high aspect ratio materials, fibrous materials, polygonal materials (such as cubic materials), and mixtures thereof. In embodiments, the carbon nanoparticles produced in the microwave pyrolysis unit may be discrete particles or may be agglomerations of small particles.

Microwave methane pyrolysis offers several advantages including more efficient energy transfer, faster reaction rates, and selective heating. Modern microwave methane pyrolysis can operate at over 90% of conversion efficiencies of electricity into thermal energy. Conventional catalysts may be used to help lower the operating temperatures and improve the yield of molecular hydrogen gas products. Conventional catalysts include metals such as nickel, iron, or cobalt, for example, metal oxides, zeolites, or any combination thereof. However, the solid carbon product of the reaction can be used as catalyst increasing the reaction rate of the microwave methane pyrolysis and improving its energy efficiency. The produced solid carbons used as catalysts are more stable and exhibit longer lifetimes than traditional metal catalysts. Therefore, the use of the produced solid carbons as catalysts is financially advantageous.

The molecular hydrogen gas generated from methane decomposition may be supplied to a fuel cell for generation of electricity in accordance with one or more embodiments. The fuel cells may be stationary or mobile. The electricity generated by the fuel cells may be used for any suitable purpose. In some embodiments, the fuel cells may be used to power well equipment, such as hydraulic fracturing equipment at a well stimulation site. The fuel cells may be coupled to the well equipment via a DC/AC converter and, in some embodiments, via a variable frequency drive (VFD). The fuel cells may be arranged in a fuel cell stack that is used to generate electricity to power various electrical devices (e.g., electric motors) on the well equipment. For example, the fuel cells may be coupled to electric motors on pumping units and used to drive hydraulic pumps on the pumping units, thereby pumping fracturing fluid to a wellhead at a desired pressure. The hydraulic pumping units may include one or more reciprocating pumps, centrifugal pumps, vane pumps, or other types of pumps. Fuel cells may be used to power other equipment on location as well, including a blender unit, a gel/advanced dry polymer (ADP) handling equipment unit, sand handling equipment, liquid handling equipment, a control center (e.g., tech center), and others. Well equipment may be driven partially or entirely by electrical power generated using the fuel cells, as opposed to diesel engines that are conventionally used on location.

The molecular hydrogen gas produced by methane pyrolysis may be fed directly into a hydrogen fuel cell to power oilfield equipment and/or any energy storage for future electricity use. The energy storage may be any storage capable of storing energy including batteries and supercapacitors. In some embodiments, the produced molecular hydrogen gas may be stored in a hydrogen storage as a metal hydride in a container or in a hydrogen well storage, which is a completed well dedicated to hydrogen storage. The stored hydrogen may be fed to a hydrogen fuel cell when electricity is needed to power oilfield equipment and/or recharge the energy storage. The stored hydrogen may need to be purified before being fed into hydrogen fuel cell. However, solid oxide fuel cells can handle methane blended with hydrogen. Therefore, solid oxide fuel cells may be used instead of hydrogen fuel cells as solid oxide fuel cells do not need any purification of hydrogen. Solid oxide fuel cells may be used in parallel with hydrogen fuel cell.

In embodiments, the hydrogen fuel cells generate electricity to charge an energy storage device that can provide electricity for future use. The energy storage device may provide electricity to power oilfield equipment such as electric drive and mechanical drive, for example. The energy storage device may be any device that can store energy including batteries and supercapacitors as discussed above. In some embodiments, the energy storage device can be used in conjunction with one or more fuel cells and/or one or more internal combustion engines to provide complementary electrical power to oilfield equipment to minimize fossil fuel consumption, thus lowering carbon dioxide emission.

In some embodiments, the system includes a reactor, a heat generator, separation units, hydrogen and carbon collection systems, waste recovery units, and monitoring and control systems. The reactor may be any type of reactor capable of performing methane pyrolysis including a continuous fluidized-bed reactor, a tubular reactor, or a batch reactor, for example. In embodiments, the reactor is a pyrolysis reactor made of refractory materials and/or high temperature alloys designed to withstand high temperatures.

The pyrolysis reactor can be heated to high temperatures by any heating method including electrical heat generator, furnaces, solar thermal collectors, or any combination thereof. The pyrolysis reactor is heated to a desired temperature ranging from about 800° C. to about 1200° C. to achieve efficient methane decomposition. Further, the temperature is carefully controlled to ensure optimal conversion and selectivity. The temperature control system may include thermocouples or infrared sensors to monitor and regulate the temperature within the reactor.

The electricity provided to the electrical heat generator can be derived from renewable energy sources including geothermal energy, solar energy, wind energy, hydroelectric energy, ocean wave energy, or nuclear energy, for example. Further, the pyrolysis reactor may be a fluidized-bed reactor comprising the produced solid carbons that can be fluidized and used as catalysts. Renewable energy may be used to electrically heat the pyrolysis reactor and optimize heat and mass transfers between the reactant, methane, and the solid carbon products acting as catalysts, to generate molecular hydrogen gas and more solid carbon products. Waste heat produced from the pyrolysis reactor may be recovered using a waste recovery unit to preheat the feed, i.e., methane or natural gas, prior to its introduction into the pyrolysis reactor. The waste heat may be recovered using a heat exchanger or steam generation system such as a Rankine system, for example. The produced molecular hydrogen gas may be fed directly into a hydrogen fuel cell to power oilfield equipment and/or recharge an energy storage for future electricity use. In some embodiments, the produced molecular hydrogen gas is stored in a hydrogen storage as discussed above. The solid carbon products may also be utilized for other processes where the solid carbon products can be permanently sequestered, thus lowering the carbon footprint of the process.

The produced molecular hydrogen gas may be separated from the solid carbon product of the methane pyrolysis reaction by condensation, adsorption, membrane separation, cryogenic distillation, or any combination thereof.

In embodiments, the microwave reactor may be made of high temperature material designed to withstand high temperatures such as reaction temperatures above 1000° C., above 1250° C., above 1500° C., above 1750° C., above 2000° C., above 2500° C., above 3000° C., above 4000° C., or above 6000° C., for example. The microwave reactor may be made of material transparent to microwaves including quartz or borosilicate glass. Further, the microwave reactor may be equipped with a waveguide system to deliver microwave energy into the reaction chamber. The microwave reactor includes a microwave generator to produce and deliver microwave energy into the reactor. For example, the microwave generator produces microwaves at a specific frequency, such as 2.45 GHz for example, that is absorbed by the methane molecules resulting in rapid heating. The microwave applicator ensures efficient energy transfer from the microwave source to the reactants. It can be in the form of a waveguide or a resonant cavity depending upon the design of the system. Microwaves selectively heat the methane molecules, inducing rapid and localized heating. The high-frequency oscillations of the microwaves preferentially heat polar molecules, such as methane, over non-polar species, facilitating the pyrolysis reaction. The heat energy breaks down methane into solid carbon and molecular hydrogen gas products. Waste heat produced from the microwave reactor may be recovered using a waste recovery unit to preheat the feed and/or reactor for the carbon dioxide-hydrogenation process.

In other embodiments, single carbon molecules such as methane and methanol may be used to power oilfield equipment and/or recharge energy storage through a methane/methanol fuel cell that generates electricity and carbon dioxide, water, and heat as byproducts as shown by Reaction 2 and Reaction 3, respectively.

$${CH}_{4} ( g ) + 2 {O}_{2} ( g ) \to {CO}_{2} ( g ) + 2 {H}_{2} O ( l ) + electricity \qquad Reaction 2$$

$$2 {CH}_{3} OH ( l ) + 3 {O}_{2} ( g ) \to 2 {CO}_{2} ( g ) + 4 {H}_{2} O ( l ) + electricity \qquad Reaction 3$$

Reaction 2 may occur at temperatures between 750° C. and 1000° C. Some methane fuel cells may be able to run with reaction temperature as low as 500° C. In contrast, direct methanol fuel cell may be able to carry Reaction 3 at operating temperatures in the range of 50° C. to 120° C.

The carbon dioxide produced by methane fuel cell or methanol fuel cell is pure and may be used to react with a hydrogen molecule, for example, that has been produced by microwave pyrolysis to generate methanol or methane via a carbon dioxide-hydrogenation process to avoid any emission of carbon dioxide in the production cycle of electricity as shown in Reaction 4 below for the production of methanol:

$${CO}_{2} ( g ) + 3 {H}_{2} ( g ) \to {CH}_{3} OH ( l ) + {H}_{2} O ( l ) \qquad Reaction 4$$

Reaction 4 may occur at temperatures between 200° C. and 300° C. or between 230° C. and 270° C., for example, using a heterogenous catalyst and pressures between 3 MPa and 10 MPa. Reaction 4 may be performed at room temperature with a homogenous catalyst. However, heterogenous catalysts are preferred for products separation, catalyst stability, and the complexity of catalyst preparation.

The methane/methanol fuel cells may be stationary or mobile. The electricity generated by the fuel cells may be used for any suitable purpose. In some embodiments, the fuel cells may be used to power well equipment, such as fracturing equipment at a well stimulation site. The fuel cells may be coupled to the well equipment via a DC/AC converter and, in some embodiments, via a variable frequency drive (VFD). The fuel cells may be arranged in a fuel cell stack that is used to generate electricity to power various electrical devices (e.g., electric motors) on the well equipment. For example, the fuel cells may be coupled to electric motors on pumping units and used to drive hydraulic pumps on the pumping units, thereby pumping fracturing fluid to a wellhead at a desired pressure. The hydraulic pumping units may include one or more reciprocating pumps, centrifugal pumps, vane pumps, or other types of pumps. Fuel cells may be used to power other equipment on location as well, including a blender unit, a gel/advanced dry polymer (ADP) handling equipment unit, sand handling equipment, liquid handling equipment, a control center (e.g., tech center), and others. Well equipment may be driven partially or entirely by electrical power generated using the fuel cells, as opposed to diesel engines that are conventionally used on location.

In embodiments, the methane/methanol fuel cells generate electricity to charge an energy storage device that can provide electricity for future use. The energy storage device may provide electricity to power oilfield equipment such as electric drive and mechanical drive, for example. The energy storage device may be any device that can store energy including batteries and supercapacitors as discussed above. In some embodiments, the energy storage device can be used in conjunction with one or more fuel cells and/or one or more internal combustion engines to provide complementary electrical power to oilfield equipment to minimize fossil fuel consumption, thus lowering carbon dioxide emission.

In some embodiments, hydrogen may be introduced together with one or more fuels into an internal combustion engine to power oilfield equipment and minimize fossil fuel consumption. The fuels of the internal combustion engine may be any fuel that can be fed to an internal combustion engine including natural gas, methane, diesel, or any secondary or tertiary fuel. Alternatively, a source of hydrogen is mixed and atomized in an atomizer with one or more fuels including natural gas, methane, diesel, or any secondary or tertiary fuel such as methanol, ethanol, propane, butane, liquid petroleum gas, for example, before introduction into an internal combustion engine to provide power to the mechanical drive.

In embodiments, the heat source to decompose methane into molecular hydrogen gas and solid carbon can be any heat source including microwave, laser, waste heat, cavitation, and any combination thereof.

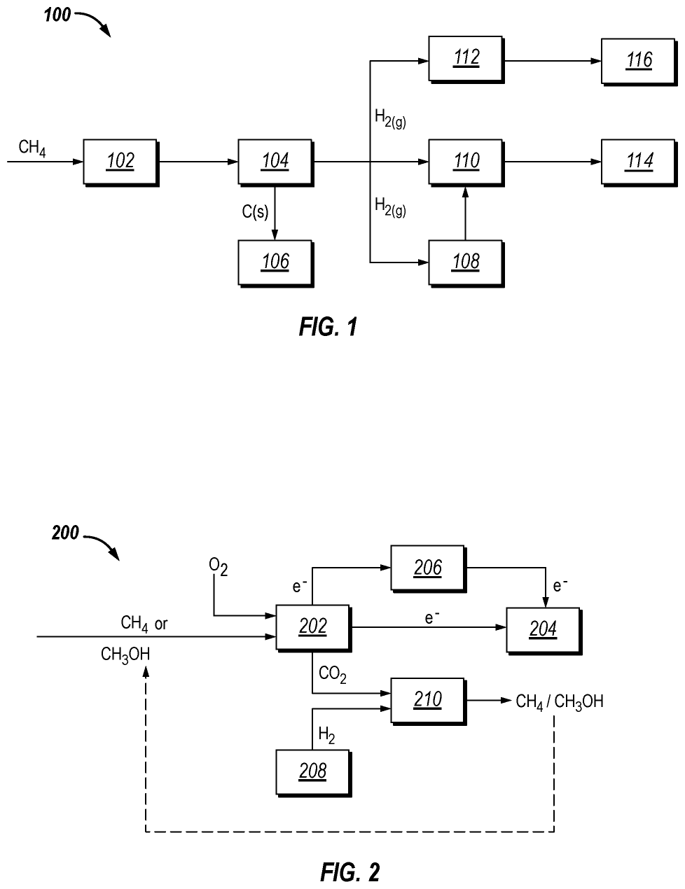

FIG. 1 is a schematic of a system 100 according to some embodiments of the present disclosure. A methane pyrolysis reactor 102 uses a source of methane to produce products comprising solid carbon and molecular hydrogen gas which are separated by a separation unit 104. The source of methane may be any source of methane capable of providing at least 70% by volume methane, 75% by volume, 80% by volume, 85% by volume, 90% by volume methane, or any range in between. Separation unit 104 is in fluid communication with solid carbon storage 106 and hydrogen storage 108, hydrogen fuel cell 110, and internal combustion engine 112. Hydrogen fuel cell 110 produces electricity to power oilfield equipment 114 and/or the electricity is stored in an energy storage (not shown). The energy storage may be used in place of hydrogen fuel cell 110 to directly power oilfield equipment 114 or may be used in combination with directly powering oilfield equipment 114 with the electricity. The energy storage may be any storage that can store energy including batteries and supercapacitors.

Methane pyrolysis reactor 102 may include, for example, microwave methane pyrolysis as previously described. Hydrogen fuel cell 110 may be stationary or mobile. In some embodiments, hydrogen fuel cell 110 may be used to directly power the oilfield equipment, for example, by powering an electric drive that drives oilfield equipment. In some embodiments, hydrogen fuel cell 110 may be coupled to the oilfield equipment 114 via a DC/AC converter and, in some embodiments, via a variable frequency drive (VFD). Hydrogen fuel cell 110 may be arranged in a fuel cell stack that is used to generate electricity to power oilfield equipment 114. Oilfield equipment 114 may include any oilfield equipment including any electric motors on pumping units and used to drive hydraulic pumps on the pumping units, thereby pumping fracturing fluid into a wellhead at a desired pressure. The hydraulic pumping units may include one or more reciprocating pumps, centrifugal pumps, vane pumps, or other types of pumps. Oilfield equipment 114 further may include a blender unit, a gel/advanced dry polymer (ADP) handling equipment, sand handling equipment, liquid handling equipment, a control center (e.g., tech center), and others.

In some embodiments, molecular hydrogen gas from methane pyrolysis reactor 102 may be stored in a hydrogen storage 108 for future use when demand for electricity is lower than the produced electricity and/or energy storage (not shown) is full. When desired, the molecular hydrogen gas from hydrogen storage 108 may then be supplied to hydrogen fuel cell 110. Molecular hydrogen gas may be stored in any storage capable of storing molecular hydrogen gas including metal hydride in a container and/or a hydrogen well storage, which is a completed well dedicated to hydrogen storage.

Molecular hydrogen gas from methane pyrolysis reactor may be supplied to internal combustion engine 112 to power oilfield equipment through a mechanical drive 116 to minimize fossil fuel consumption, thus lowering carbon dioxide emission. Molecular hydrogen gas is introduced together with one or more fuels into internal combustion engine 112 to power oilfield equipment through mechanical drive 116 and minimize fossil fuel consumption. The fuels of the internal combustion engine may be any fuel that can be fed to an internal combustion engine including natural gas, diesel, or any secondary or tertiary fuel. Alternatively, molecular hydrogen gas produced by methane pyrolysis reactor 102 is mixed and atomized in an atomizer with one or more fuels including natural gas, diesel, or any secondary or tertiary fuel such as methanol, ethanol, propane, butane, liquid petroleum gas, for example, before introduction into internal combustion engine 112 to power oilfield equipment through mechanical drive 116.

Heat integration may be used in system 100, for example, to reduce heat requirements (not shown). For example, the waste heat generated by the fuel cells and/or the well equipment may be captured in a waste heat recovery unit in accordance with one or more embodiments. The waste heat recovery unity may include, for example, one or more heat exchanger. For example, a heat exchanger(s) may recover waste heat from the fuel cell for use in the methane decomposition in methane pyrolysis reactor 102. By way of example, an additional heat exchanger(s) may recover waste heat from the well equipment to heat the methane inlet to methane pyrolysis reactor 102. The heat recovered in the waste heat recovery unity may be transferred, for example, to any suitable heat transfer medium such as a heat transfer fluid (liquid or gas), a solid conductive material, or electromagnetic waves. For example, the thermal energy can be transported using any suitable heat transfer liquid such as hydrocarbon oil, or synthetic oil, molten salts, and molten metals, or silicon-based fluids, as well as, but also gases such as water vapor, nitrogen, argon, carbon dioxide, or helium. Additional heat transfer liquids such as liquid water, glycol-based liquid or any other heavy-duty antifreeze liquid can also be used in additional examples.

FIG. 2 is a schematic of a system 200 in accordance with some embodiments of the present disclosure. A one-carbon molecule may be provided to a methane/methanol fuel cell 202 that produces electricity, pure carbon dioxide, and water from methane or methanol. In some embodiments, the one-carbon molecule may include methane. The source of methane may be any source of methane capable of providing at least 95% by volume pure methane such as methane gas released from a wellhead, captured methane from landfills, captured methane from livestock and other agricultural practices, captured methane from steam methane reforming, or captured methane from the decay of organic waste, for example. In some embodiments, methane gas from the wellhead may be supplemented with additional fuel delivered to the location. In some embodiments, the methane gas may include waste gas that is typically flared. Further, methane may be replaced by natural gas. In some embodiments, the one-carbon molecule may include methanol.

As illustrated on FIG. 2, the methane/methanol fuel cell 202 may generate electricity. The electricity from the methane/methanol fuel cell 202 may be used to power oilfield equipment 204. In some embodiments, the electricity may be used to directly power oilfield equipment 204, for example, by powering an electric drive that drives oilfield equipment 204. In some embodiments, the electricity may be stored in an energy storage 206. In some embodiments, methane/methanol fuel cell 202 may be coupled to the oilfield equipment 204 via a DC/AC converter and, in some embodiments, via a variable frequency drive (VFD). Methane/methanol fuel cell 202 may be arranged in a fuel cell stack that is used to generate electricity to power oilfield equipment 204. Oilfield equipment 204 may include any oilfield equipment including any electric motors on pumping units and used to drive hydraulic pumps on the pumping units, thereby pumping fracturing fluid into a wellhead at a desired pressure. The hydraulic pumping units may include one or more reciprocating pumps, centrifugal pumps, vane pumps, or other types of pumps. Oilfield equipment 204 further may include a blender unit, a gel/advanced dry polymer (ADP) handling equipment, sand handling equipment, liquid handling equipment, a control center (e.g., tech center), and others.

In some embodiments, electricity generated by methane/methanol fuel cell 202 may be stored in energy storage 206. Energy storage 206 may be used in place of directly powering oilfield equipment 204 or may be used in combination with directly powering oilfield equipment 204 with the electricity produced by methane/methanol fuel cell 202. Energy storage 206 may be any storage that can store energy including batteries and supercapacitors. When needed, electricity from energy storage 206 may be used to power an electric drive that drives oilfield equipment 204. The energy from methane/methanol fuel cell 202 may be stored in energy storage 206, for example, when more electricity is generated than needed to power oilfield equipment 204. Alternatively, energy storage 206 may be used in place of directly powering oilfield equipment 204 with the electricity such that electricity from methane/methanol fuel cell 202 is first stored in energy storage 206 then supplied to oilfield equipment 204.

Further, methane/methanol fuel cell 202 may produce carbon dioxide as a byproduct. As previously discussed, carbon dioxide may be reacted with hydrogen to produce methane and/or methanol. Accordingly, system 200 further includes a methane/methanol generator 210 that receives carbon dioxide from the methane/methanol fuel cell 202 for reaction with hydrogen, thus generating methane and/or methanol. In some embodiments, the carbon dioxide may be combined with the molecular hydrogen gas produced by a methane pyrolysis reactor 208 in a methane/methanol generator 210 to form methanol and/or methane via a carbon dioxide-hydrogenation process as discussed above. The methane and/or methanol produced in methane/methanol generator 210 may be recycled to methane/methanol fuel cell 202, for example, to reduce the methane/methanol requirement.

In some embodiments, system 200 may further include methane pyrolysis reactor 208. Methane pyrolysis reactor 208 produces solid carbon and molecular hydrogen gas, which may be fed to methane/methanol generator for producing methane and/or methanol from reaction with carbon dioxide. Methane pyrolysis reactor 208 may include, for example, microwave methane pyrolysis as previously described. Microwave pyrolysis reactor 208 comprises a plasma chamber, a microwave-feeding resonator with a microwave generator for forming the plasma and coupling points in the metal wall between the resonator and plasma chamber for coupling the microwave into the plasma chamber. An inlet stream containing methane (not shown) is introduced into the plasma chamber and exposed to microwave plasma with a sufficient power density to cause at least a portion of the methane from the inlet stream to decompose to form molecular hydrogen gas and solid carbon. Methane pyrolysis is performed in microwave pyrolysis reactor 208 comprising a reaction chamber positioned within an opening of a waveguide and a microwave generator configured to generate microwaves and feed the microwaves into the waveguide. An inlet stream containing methane is introduced into the reaction chamber and microwave energy is propagated through the waveguide into the reaction tube at a sufficient power density to cause at least a portion of the methane from the inlet stream to decompose to form hydrogen and carbon nanoparticles.

Heat integration may be used in system 200, for example, to reduce heat requirements (not shown). For example, the waste heat generated by the methane/methanol fuel cells 202 and/or the oilfield equipment 204 may be captured in a waste heat recovery unit in accordance with one or more embodiments. The waste heat recovery unity may include, for example, one or more heat exchanger. For example, a heat exchanger(s) may recover waste heat from the methane/methanol fuel cell 202 for use in the methane decomposition in methane pyrolysis reactor 208. By way of example, an additional heat exchanger(s) may recover waste heat from the oilfield equipment 204 to heat the methane inlet to methane pyrolysis reactor 208. The heat recovered in the waste heat recovery unity may be transferred, for example, to any suitable heat transfer medium such as a heat transfer fluid (liquid or gas), a solid conductive material, or electromagnetic waves. For example, the thermal energy can be transported using any suitable heat transfer liquid such as hydrocarbon oil, or synthetic oil, molten salts, and molten metals, or silicon-based fluids, as well as, but also gases such as water vapor, nitrogen, argon, carbon dioxide, or helium. Additional heat transfer liquids such as liquid water, glycol-based liquid or any other heavy-duty antifreeze liquid can also be used in additional examples.

FIG. 3 is a schematic of a system 300 in accordance with some embodiments of the present disclosure. A microwave methane pyrolysis reactor 302 produces solid carbon and molecular hydrogen gas that feeds an internal combustion engine 304 that powers oilfield equipment 308. Methane pyrolysis reactor 302 may include, for example, microwave methane pyrolysis as previously described. Methane pyrolysis is performed in microwave pyrolysis reactor 302 configured to perform microwave plasma pyrolysis and/or microwave-assisted pyrolysis. Microwave pyrolysis reactor 302 comprises a plasma chamber, a microwave-feeding resonator with a microwave generator for forming the plasma and coupling points in the metal wall between the resonator and plasma chamber for coupling the microwave into the plasma chamber. An inlet stream containing methane is introduced into the plasma chamber and exposed to microwave plasma with a sufficient power density to cause at least a portion of the methane from the inlet stream to decompose to form molecular hydrogen gas and solid carbon. Methane pyrolysis is performed in microwave pyrolysis reactor 302 comprising a reaction chamber positioned within an opening of a waveguide and a microwave generator configured to generate microwaves and feed the microwaves into the waveguide. An inlet stream containing methane (not shown) is introduced into the reaction chamber and microwave energy is propagated through the waveguide into the reaction tube at a sufficient power density to cause at least a portion of the methane from the inlet stream to decompose to form hydrogen and carbon nanoparticles.

If the microwave methane pyrolysis reactor 302 produces more molecular hydrogen gas than the internal combustion engine 304 needs, molecular hydrogen gas is stored in a hydrogen storage 306 for future use. If internal combustion engine 304 provides more energy than oilfield equipment 308 needs, the excess energy is stored in an energy storage 310 for future use.

Heat integration may be used in system 300, for example, to reduce heat requirements (not shown). For example, the waste heat generated by the internal combustion engine 304 and/or oilfield equipment 308 may be captured in a waste heat recovery unit in accordance with one or more embodiments. The waste heat recovery unity may include, for example, one or more heat exchanger. For example, a heat exchanger(s) may recover waste heat from the fuel cell for use in the methane decomposition in methane pyrolysis reactor 302. By way of example, an additional heat exchanger(s) may recover waste heat from the oilfield equipment 308 to heat the methane inlet to methane pyrolysis reactor 302. The heat recovered in the waste heat recovery unity may be transferred, for example, to any suitable heat transfer medium such as a heat transfer fluid (liquid or gas), a solid conductive material, or electromagnetic waves. For example, the thermal energy can be transported using any suitable heat transfer liquid such as hydrocarbon oil, or synthetic oil, molten salts, and molten metals, or silicon-based fluids, as well as, but also gases such as water vapor, nitrogen, argon, carbon dioxide, or helium. Additional heat transfer liquids such as liquid water, glycol-based liquid or any other heavy-duty antifreeze liquid can also be used in additional examples.

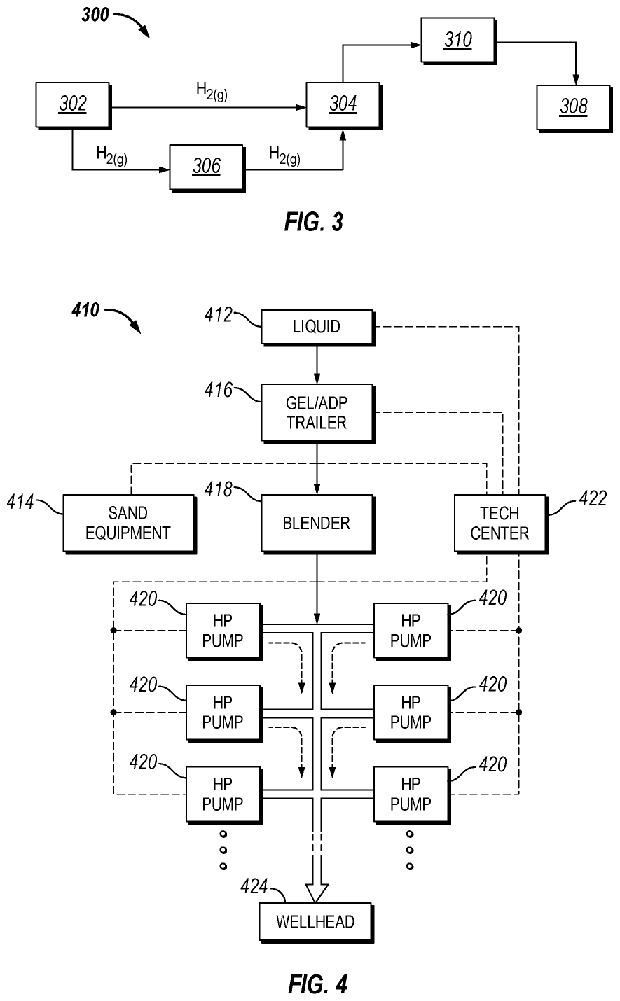

FIG. 4 is a block diagram of a well stimulation equipment spread 410 used in treatment (e.g., hydraulic fracturing treatment) of a well. FIG. 4 is an example illustration of the oilfield equipment that can be use with any of the systems disclosed herein such as system 100 on FIG. 1, system 200 on FIG. 2, and system 300 on FIG. 3. The fracturing spread 410 may include liquid handling equipment 412, sand handling equipment 414, gel/advanced dry polymer (ADP) handling equipment 416, a blender unit 418, a plurality of hydraulic pumping units 420, a control center 422 (e.g., tech center), and a wellhead 424. In some embodiments, the fracturing spread 410 may not include all of the components illustrated. For example, the fracturing spread 410 may not include a gel/advanced dry polymer (ADP) handling equipment 416 when the gel/advanced dry polymer (ADP) handling equipment is not needed to create a desired treatment fluid. In some embodiments, one or more stimulation (e.g., fracturing) equipment components may be separated into two or more separate units. In still other embodiments, two or more of the illustrated equipment components may be incorporated into a single unit. It should be noted that additional equipment components not shown in FIG. 4 may be located at the well site as well, and different numbers and arrangement of the illustrated well stimulation equipment may be used.

In a general well stimulation (e.g., fracturing) operation, liquid handling equipment 412 may provide water that is entirely made up of potable water, freshwater, and/or treated water for mixing a desired treatment fluid. Other liquid may be provided from liquid handling equipment 412 as well. The water (or other liquid) may be mixed with a viscosity-increasing agent in the gel/advanced dry polymer (ADP) handling equipment 416 to provide a higher viscosity fluid to help suspend sand or other particulates. Sand handling equipment 414 may output dry bulk material such as sand, proppant, and/or other particulates into blender unit 418 at a metered rate. Blender unit 418 may mix the sand with the higher-viscosity water-based fluid in a mixing compartment to form a treatment fluid for fracturing the well. As mentioned above, similar equipment components may be utilized to mix various types of treatment fluids for use in other well stimulation applications (i.e., not limited to fracturing).

Blender unit 418 may be coupled to an array of hydraulic pumping units 420 via a manifold 426. Although only six pumping units 420 are illustrated, several more pumping units 420 may be positioned on location. Hydraulic pumping units 420 are arranged in parallel and used to deliver the treatment fluid to the wellhead 424 such that the treatment fluid is pumped into the wellbore at a desired pressure for performing the wellbore stimulation.

The control center 422 may be communicatively coupled to various sensing and/or control components on the other stimulation equipment. Control center 422 may include data acquisition components and one or more processing components used to interpret sensor feedback and monitor the operational states of the stimulation equipment located at the well site. In some embodiments, control center 422 may output control signals to one or more actuation components of the stimulation equipment to control the well stimulation operation based on the sensor feedback.

Fracturing spread 410, many of the large well stimulation equipment components (e.g., liquid handling unit 412, sand handling equipment 414, gel/advanced dry polymer (ADP) handling equipment 416, blender unit 418, hydraulic pumping units 410, and tech center 422) must be electrically powered. The power requirements for these components together may be on the order of approximately 30 Megawatts. However, the equipment may have a power requirement that is more or less than this estimated requirement. The disclosed embodiments are directed to using one or more stacks of fuel cells to generate electricity for powering the stimulation equipment present in the fracturing spread 410, instead of using internal/external combustion engines to drive a generator. One or more fuel cell units may be coupled to and used to power liquid handling equipment 412, sand handling equipment 414, gel/advanced dry polymer (ADP) handling equipment 416, blender unit 418, hydraulic pumping units 420, tech center 422, or a combination thereof, or any other electrically powered equipment on location.

Statement 1. A method comprising: converting a one-carbon-containing molecule into electricity with a co-production of carbon dioxide; pyrolyzing at least methane to produce at least carbon and hydrogen; and reacting at least a portion of the carbon dioxide and at least a portion of the hydrogen to produce at least additional one-carbon-containing molecule.

Statement 2. The method of statement 1, wherein the additional one-carbon-containing molecule comprises methane and the method further comprises converting at least a portion of the methane of the additional one-carbon-containing molecule into additional electricity with a co-production of additional carbon dioxide.

Statement 3. The method of statement 1 or statement 2, wherein the one-carbon containing molecule and the additional one-carbon containing molecule each individually comprise methanol.

Statement 4. The method of any of statements 1-3, wherein the converting the one-carbon-containing molecule into electricity comprises introducing at least a portion of the one-carbon-containing molecule to a fuel cell to generate at least electricity and heat.

Statement 5. The method of any of statements 1-4, further comprising capturing at least a portion of the heat from the fuel cell to preheat the methane source prior to the pyrolyzing.

Statement 6. The method of any of statements 1-5, further capturing at least a portion of the heat from the fuel cell to reduce an electricity requirement for the conversion of the methane source.

Statement 7. The method of any of statements 1-6, further comprising capturing at least a portion of heat from the pyrolyzing to preheat the methane prior to the pyrolyzing.

Statement 8. The method of any of statements 1-7, f wherein the pyrolyzing the methane comprises heating the methane with microwaves.

Statement 9. The method of any of statements 1-8, wherein the methane is present in a produced natural gas in an amount of about 70% by volume to about 80% by volume.

Statement 10. The method of any of statements 1-9, further comprising powering oilfield equipment with the electricity.

Statement 11. The method of any of statements 1-10, wherein the electricity is stored in an energy storage before powering the oilfield equipment.

Statement 12. The method of any of statements 1-11, wherein the electricity is used to power an electric drive of the oilfield equipment.

Statement 13. A method comprising: pyrolyzing methane to produce at least solid carbon and hydrogen; feeding at least a portion of the hydrogen to a fuel cell to produce electricity and heat; capturing at least a portion of the heat from the fuel cell; preheating the methane prior to the pyrolyzing with the captured heat from the fuel cell; and powering oilfield equipment with at least a portion of the electricity.

Statement 14. The method of statement 13, wherein the methane is present in a produced natural gas in an amount of about 70% by volume to about 80% by volume.

Statement 15. The method of statement 13 or statement 14, wherein the pyrolyzing the methane comprises heating the methane with microwaves.

Statement 16. The method of any of statements 13-15, wherein at least a portion of the electricity from the fuel cell is stored in an energy storage and then used to power the oilfield equipment.

Statement 17. The method of any of statements 13-16, wherein the electricity is used to power an electric drive of the oilfield equipment.

Statement 18. The method of any of statements 13-17, wherein at least a portion of the hydrogen is stored in a hydrogen storage and then fed to the fuel cell.

Statement 19. The method of any of statements 13-18, wherein the hydrogen storage comprises a hydrogen well storage.

Statement 20. The method of any of statements 13-19, wherein the pyrolyzing of the methane source uses renewable energy.

It should be understood that the compositions and methods are described in terms of “comprising,” “containing,” or “including” various components or steps, the compositions and methods can also “consist essentially of” or “consist of” the various components and steps. Moreover, the indefinite articles “a” or “an,” as used in the claims, are defined herein to mean one or more than one of the elements that it introduces.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present disclosure is well adapted to attain the ends and advantages mentioned as well as those that are inherent therein. The particular examples disclosed above are illustrative only, as the present disclosure may be modified and practiced in different but equivalent manners apparent to those skilled in the art having the benefit of the teachings herein. Although individual examples are discussed, the disclosure covers all combinations of all those examples. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative examples disclosed above may be altered or modified and all such variations are considered within the scope and spirit of the present disclosure. If there is any conflict in the usages of a word or term in this specification and one or more patent(s) or other documents that may be incorporated herein by reference, the definitions that are consistent with this specification should be adopted.

What is claimed is:

1. A method comprising:
converting a one-carbon-containing molecule into electricity with a co-production of carbon dioxide;
pyrolyzing at least methane to produce at least carbon and hydrogen; and
reacting at least a portion of the carbon dioxide and at least a portion of the hydrogen to produce at least additional one-carbon-containing molecule.

2. The method of claim 1, wherein the additional one-carbon-containing molecule comprises methane and the method further comprises converting at least a portion of the methane of the additional one-carbon-containing molecule into additional electricity with a co-production of additional carbon dioxide.

3. The method of claim 1, wherein the one-carbon containing molecule and the additional one-carbon containing molecule each individually comprise methanol.

4. The method of claim 1, wherein the converting the one-carbon-containing molecule into electricity comprises introducing at least a portion of the one-carbon-containing molecule to a fuel cell to generate at least electricity and heat.

5. The method of claim 4, further comprising capturing at least a portion of the heat from the fuel cell to preheat a methane source prior to the pyrolyzing.

6. The method of claim 5, further capturing at least a portion of the heat from the fuel cell to reduce an electricity requirement for the conversion of the methane source.

7. The method of claim 1, further comprising capturing at least a portion of heat from the pyrolyzing to preheat the methane prior to the pyrolyzing.

8. The method of claim 1, wherein the pyrolyzing the methane comprises heating the methane with microwaves.

9. The method of claim 1, wherein the methane is present in a produced natural gas in an amount of about 70% by volume to about 80% by volume.

10. The method of claim 1, further comprising powering oilfield equipment with the electricity.

11. The method of claim 10, wherein the electricity is stored in an energy storage before powering the oilfield equipment.

12. The method of claim 10, wherein the electricity is used to power an electric drive of the oilfield equipment.

13. A method comprising:
pyrolyzing methane to produce at least solid carbon and hydrogen;
feeding at least a portion of the hydrogen to a fuel cell to produce electricity and heat;
capturing at least a portion of the heat from the fuel cell;
preheating the methane prior to the pyrolyzing with the captured heat from the fuel cell; and
powering oilfield equipment with at least a portion of the electricity.

14. The method of claim 13, wherein the methane is present in a produced natural gas in an amount of about 70% by volume to about 80% by volume.

15. The method of claim 13, wherein the pyrolyzing the methane comprises heating the methane with microwaves.

16. The method of claim 13, wherein at least a portion of the electricity from the fuel cell is stored in an energy storage and then used to power the oilfield equipment.

17. The method of claim 13, wherein the electricity is used to power an electric drive of the oilfield equipment.

18. The method of claim 13, wherein at least a portion of the hydrogen is stored in a hydrogen storage and then fed to the fuel cell.

19. The method of claim 18, wherein the hydrogen storage comprises a hydrogen well storage.

20. The method of claim 13, wherein the pyrolyzing of a methane source uses renewable energy.
